(19) United States
(12) Patent Application Publication
(10) Pub. No.: US 2019/0376654 A1
(43) Pub. Date: Dec. 12, 2019

(54) SILOUHETTE LIGHT

(71) Applicant: Alpine Corporation, Los Angeles, CA (US)

(72) Inventor: Jodie Winters, Woodland Hills, CA (US)

(21) Appl. No.: 16/231,288

(22) Filed: Dec. 21, 2018

Related U.S. Application Data
(60) Provisional application No. 62/681,874, filed on Jun. 7, 2018.

(51) Int. Cl. F21S 4/10; F21S 4/22; H02J 7/35; F21L 4/08; H02S 40/38

(52) U.S. Cl. CPC F21S 4/10; F21S 4/22; H02S 40/38; F21L 4/08; H02J 7/35

(57) ABSTRACT

Provided is a lighting product, comprising: a) a silhouette; b) a solar panel attached to the silhouette; c) a rechargeable battery in electronic communication with the solar panel; and d) a light source in electronic communication with the rechargeable battery for powering the light source.

### CROSS-REFERENCE

The present invention claims the priority of provisional patent application No. 62/681,874, filed on Jun. 7, 2018, which is incorporated herein by reference in its entirety.

### BACKGROUND SECTION OF THE INVENTION

People like to decorate their gardens with various decorative products. A problem with decorating gardens, especially with products that have lights, is that there is a limited number of products that light up and are suitable for a garden. There is a need in the art for additional decorative products that light up and are suitable for a garden.

### SUMMARY SECTION OF THE INVENTION

Provided is a lighting product, comprising: a) a silhouette; b) a solar panel attached to the silhouette; c) a rechargeable battery in electronic communication with the solar panel; and d) a light source in electronic communication with the rechargeable battery for powering the light source. The silhouette can represent an outline of a boy or a girl. The lighting product can comprise a member attached to the silhouette. The member can be configured to be held by a hand. The member can have a rod that is configured to be held by a hand through the rod or a string. The member can be an umbrella, a net, a kite, or a balloon. The light sources are not placed, in one embodiment, on the silhouette. The light sources can be placed on the member. The light sources can be a plurality of spaced LEDs. The front side of the silhouette can be flat and uniform. The solar panel can be placed on a back of the silhouette. The rod can be on the back side. The solar panel can be attached to the rod. The member can have a round portion, and the wire the plurality of the light sources wraps around the member. The silhouette can be configured to be attached to a ground.

Provided a lighting product, comprising: a) a silhouette having an outline of a person with at least one arm, the silhouette having a front and a back side; b) a solar panel housing comprising a rechargeable battery and a solar panel in electronic communication with the each other attached to the back side of the silhouette; c) a connector attached to the arm of the silhouette; d) a decorative member attached to the connector, e) a plurality of lights placed on the decorative member, wherein the plurality of lights are powered by the rechargeable battery. The decorative member can be a balloon, kite, umbrella or a net. The connector can be a string or a rod. The support structure can be on the back side of the silhouette for attaching the solar panel housing. The silhouette can be configured to be attached to a ground.

### BRIEF DESCRIPTION OF THE INVENTION

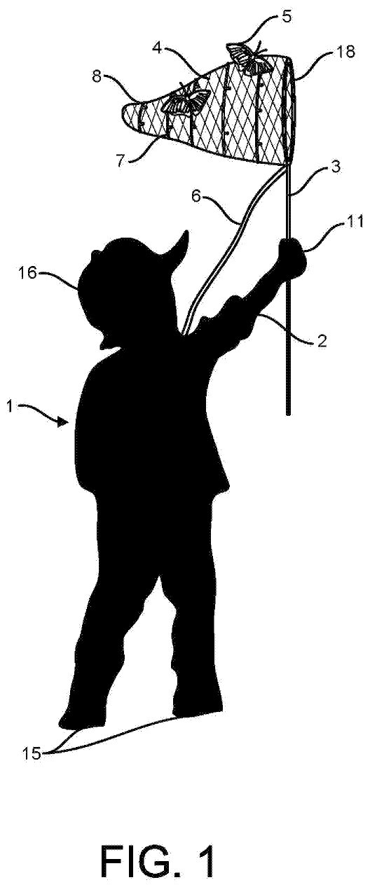

FIG. 1 illustrates a silhouette holding a net.

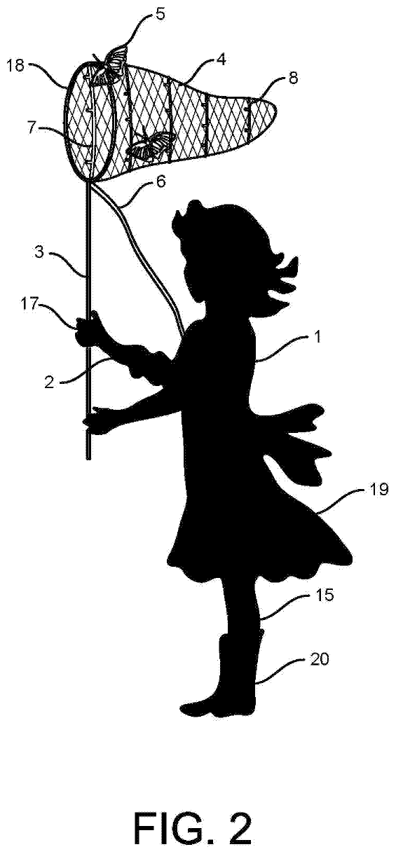

FIG. 2 illustrates a silhouette holding a net.

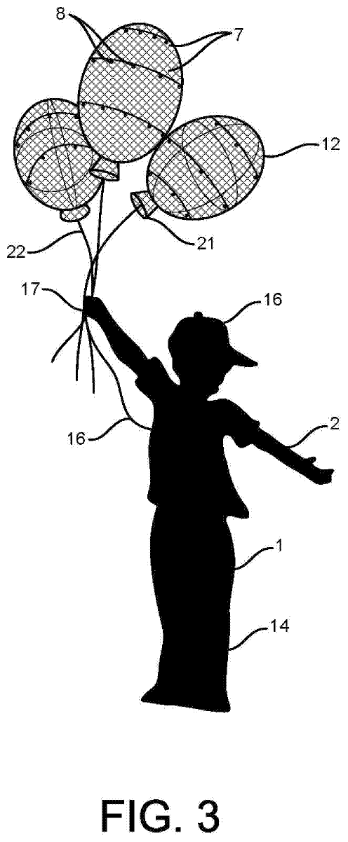

FIG. 3 illustrates a silhouette holding balloons.

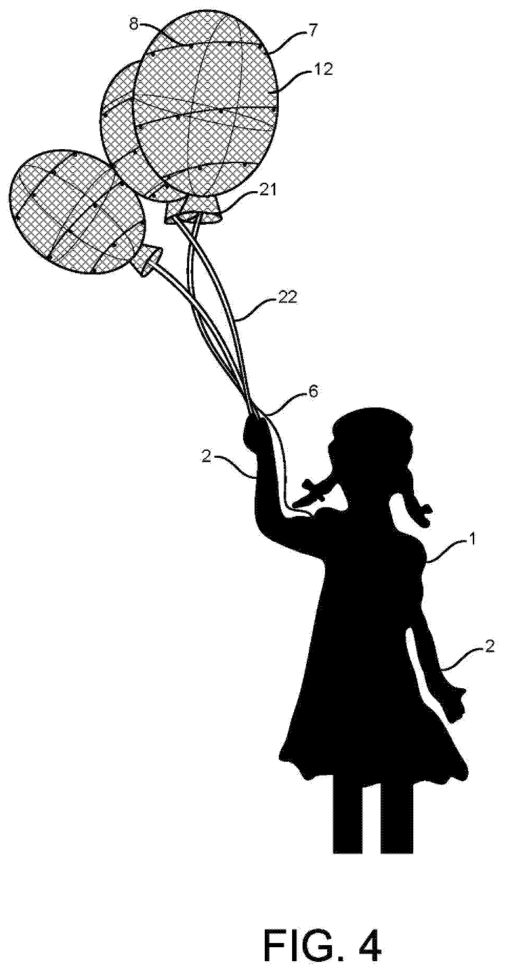

FIG. 4 illustrates a silhouette holding balloons.

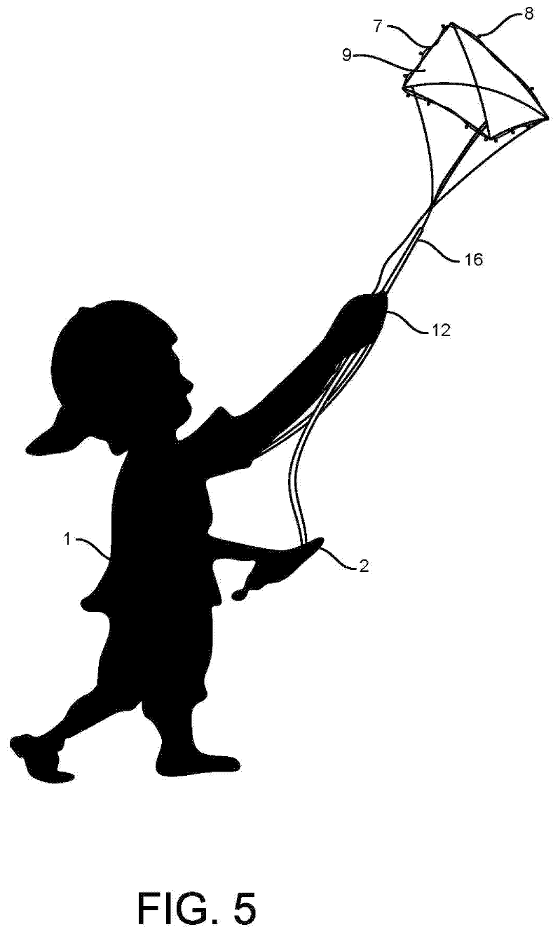

FIG. 5 illustrates a silhouette holding kite.

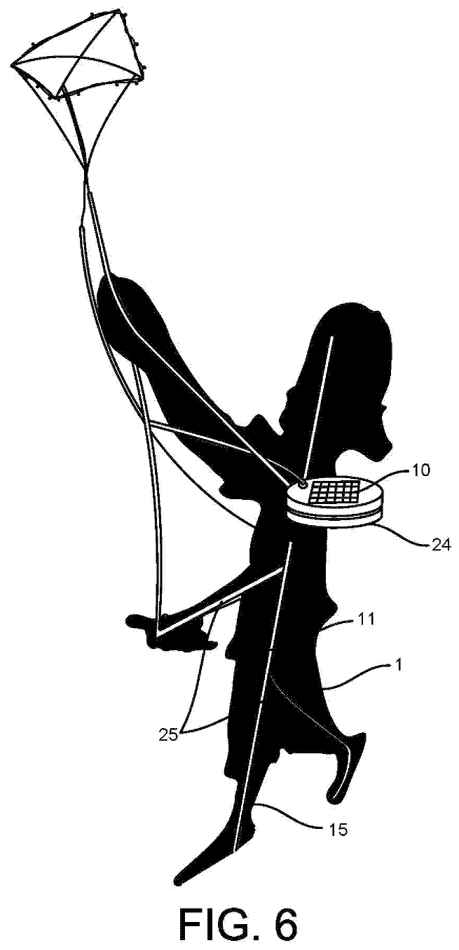

FIG. 6 illustrates a silhouette holding kite.

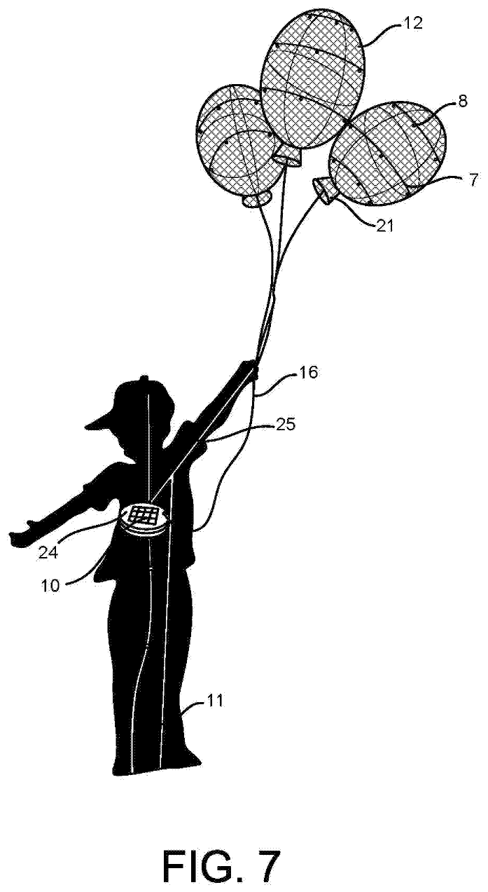

FIG. 7 illustrates a silhouette holding balloons.

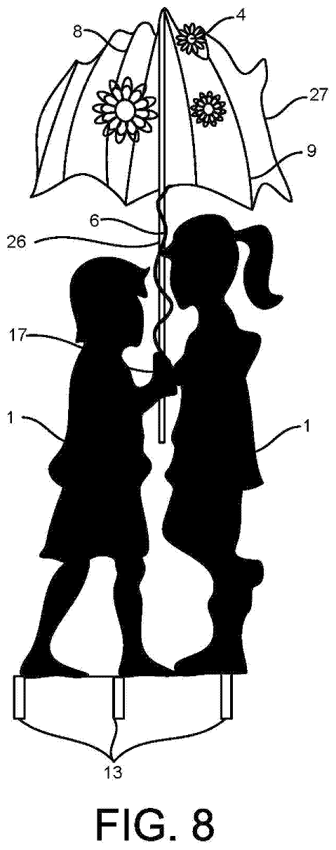

FIG. 8 illustrates two silhouettes holding an umbrella.

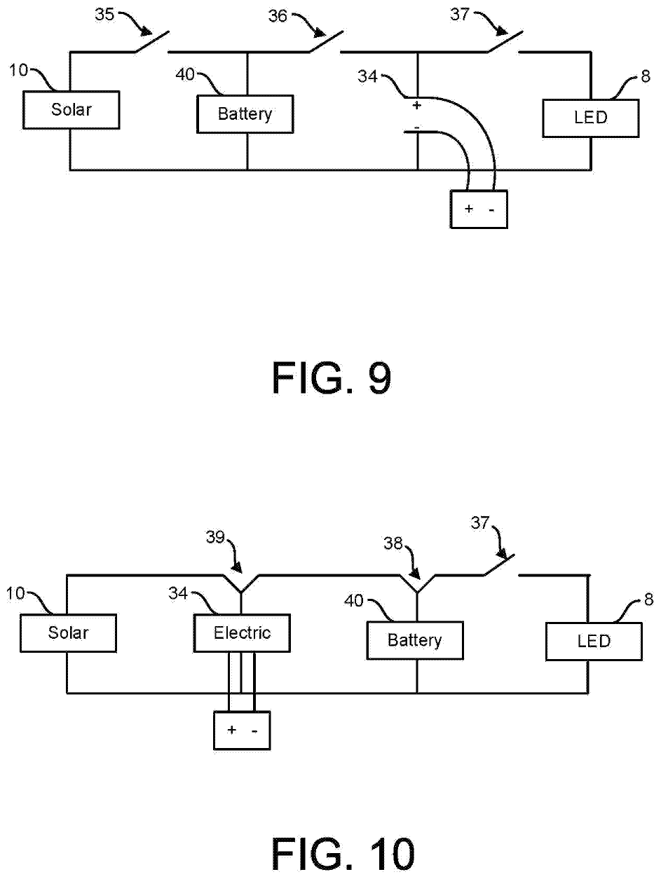

FIG. 9 illustrates various electronic components and circuitry.

FIG. 10 illustrates various electronic components and circuitry.

### DETAILED DESCRIPTION OF THE INVENTION

Provided is a decorative garden product made up of a silhouette 1 that is suitable tbr a garden and can light up. As used herein, a silhouette is the image of a person, animal, object or scene represented as a solid shape of one or more colors (preferably a single color), usually black, with its edges matching the outline of the subject.

FIG. 1 illustrates a silhouette 1 in the shape of a human, specifically a young boy. The silhouette 1 has two legs 15, two arms 2, and is wearing a cap 16. The silhouette 1 is standing upright and holding a rod 3 for a net 4 in one hand 17. The rod 3 is held in a vertical orientation. A conical shaped net 4 is attached to a ring 18 that is placed at one end of the rod 3. An LED wire 6 goes around the net 4. The LED wire 7 has a plurality of spaced LED 8 light sources. One or more design elements, in this case an insect such as a butterfly 5, can be placed on the net 4. As illustrated in FIG. 8, stake(s) can be placed at the base of the silhouette 1.

FIG. 2 illustrates a silhouette 1 of a young girl holding a net 4. A side profile of the young girl is shown in a standing position. The young girl is shown with a dress 19, two arms 2, and one leg 15, wearing a boot 20. The rod 3 of the net 4 is held in a vertical orientation with both hands 17. A ring 18 and a conical net 4 with lighting LEDs 8 is attached to the ring in a similar fashion as FIG. 1. There is a stake 13 placed at the base of the silhouette 1.

FIG. 3 illustrates a silhouette 1 of a young man holding one or more balloons 12, in this case three balloons. A front profile of a young man is illustrated with the legs merged 14, a sideway head with a cap 16, and two arms 2 extended in opposite orientation, with one arm pointing upward and another arm pointing downward. One or more balloons 12 are attached to the arm pointing upward. An electric wire 6 carrying electric current goes from behind the silhouette 1 to each balloon 12 LED wire 7 which powers a plurality of spaced LED lights 8. The balloons 12 may have a mesh support structure made of material such as metal with the LED wire 7 and LEDs 8 running along the surface of the balloons 12. A support 22 that looks like a balloon string to a user is attached the balloons 12 and the silhouette's hand 17. An electric wire 6 from the back side of the silhouette wraps around the support 22 and goes to each of the balloons 12. Each balloon 12 (optionally some of the balloons can be lighted) has a balloon wire 7 with a plurality of spaced LED lights 8 for lighting the balloons 12. The wire 7 with the LED lights 8 goes around the balloon 2-4 times at different locations of the balloon 12. The balloons 12 may have a mesh support structure made of material such as aluminum with the electrical wire 7 and LEDs 8 running along the surface of the balloons 12. As illustrated in FIG. 8, there will be a stake(s) placed at the base of the silhouette

Each balloon 12 can have a frusto-conical structure 21 at the bottom inside of which the balloon wire 22 is positioned. Each balloon 12 can be made from a mesh material with structural support on the inside. The wire 7 with the plurality of LED lights 8 can travel outside of the balloon 12. Support 23, balloons 12, and the silhouette 1 can be made from a metal, such as aluminum.

FIG. 4 illustrates a silhouette 1 of a front facing young girl with one arm 2 down and one arm 2 raised. The arm 2 that is raised is holding a hard support structure that looks like a balloon string 23. The balloon strings 22 can be made of a cylindrical metal that is slightly bend to give the impression of a balloon 12. An electric wire 6 carrying current can go from the back of the silhouette 1, wrap around one or more of the supports 22 and go to the balloons 12. The wire 6 can go around the balloons several times (2-5 times for example), and can connect one balloon 12 to another in series, or independent wires 6 can be used for each balloon 8. A plurality of spaced LED lights 8 are placed on the LED wire 7 that wraps around the balloon 8. As illustrated in FIG. 8, there will be a stake(s) placed at the base of the silhouette 1.

FIG. 5 illustrates a silhouette 1 of a young boy in a side orientation holding a kite 9. The boy is holding a kite string 23 with one hand 17 up raised above the head and the other hand 17 perpendicular to the silhouette 1. The kite string/wire 6 is a cylindrical piece of metal with an electric wire 7 wrapped around it. A wire 7 with a plurality of spaced LED 8 lights is placed around and/or on the down/up surface of the kite 9. The kite 9 is placed above the silhouette 1. As illustrated in FIG. 8, there will be a stake(s) placed at the base of the silhouette 1.

FIGS. 1-5 illustrated the front side of the silhouette 1. The front side of the silhouette 1 has a clean look, is typically a flat surface with no additional members attached thereto. FIGS. 6-7 illustrate the back side of the silhouette 1. FIG. 6 illustrates the back side of FIG. 5 and FIG. 7 illustrates the back side of FIG. 3.

As illustrated in FIGS. 6 and 7, a solar panel 10 is placed in the backside of the silhouette 1. The solar panel 10 is typically not visible from the front of the silhouette 1. Support structures 11 in the form of rods/scaffolds can be placed in the back of the silhouette 1. For example, there can be a continuous or discontinuous vertical rod support 11 in the back of the silhouette 1. The solar panel 10 can be attached to the vertical rod support structures 11. The solar panel 10 is contained within a solar panel housing 24. The solar panel housing 24 contains a rechargeable battery. One or more side-way rods 25 can be attached to the vertical rod 11 and can go behind one or more legs 15 or arms 2 of the silhouette 1.

The silhouettes of FIGS. 1-7 can have one or more stakes stake at the bottom as illustrated in FIG. 8. The stake can be used to attach the silhouettes to the ground, particularly in gardens. Silhouette 1 can be one to five feet in height (without the stake).

One or more parts of the decorative product can be detachably attached to the silhouette portion to allow for shipping and packaging of the product. For example in FIG. 1 the net 4 may be detached from the silhouette 1 at the point where it is attached to the hand 17 to facilitate boxing for shipment or storage.

FIG. 8 illustrates a side-facing silhouette 1 of a young boy and young girl facing each other with their hands 17 connected to one another. An umbrella rod 26 attached to an umbrella 27 in the open position is secured between the hands 17 the silhouette 1. The umbrella 27 may contain various design elements 5 such as flowers. An electrical wire 6 runs from behind the silhouette 1 up the length of the umbrella rod 26 and connect to the LED wires 7 that supply current to the LEDs 8 placed along the structure of the umbrella 27. Stake(s) 13 can be used to attach the silhouettes to the ground, particularly in gardens.

FIG. 9 illustrates an exemplary circuit where in addition to a solar panel 10 and a rechargeable battery 40, an optional connection to an external source of electricity 34, such as from an outlet, is provided. When there is no outside source of electricity, during daytime, switch 35 is closed and switch 36 is open, allowing the solar panel to charge the battery 40 without lighting the LED light 3. If there is no light outside to charge the solar panel 10, switch 35 opens, and switches 36 and 37 close, lighting the LED 3. Switch 37 can be an external switch or be in a closed position at all times if desired. When an outside source of electricity is used, switch 35 opens regardless of the lighting condition, and disconnects the solar panel 10. In one embodiment, only switch 37 stays closed, and the outside electric source only lights up the LED 8. In another embodiment, both switches 36 and 37 stay closed, with the outside electric source both charging the battery 40 and lighting the LED 8. Switches 35, 36, and 37 can be automatic internal switches. Alternatively switches 35 and 36 can be internal switches, with switch 37 acting as an external kill switch.

FIG. 10 illustrates an exemplary circuit where in addition to a solar panel 10 and a rechargeable battery 40, an optional connection to an external source of electricity 34, such as from an outlet, is provided. When there is no outside source of electricity, during daytime, switch 39 has no connection to the outside source of electricity 34 and is connected to the battery 40. Switch 38 also has a connection to the battery 40 in this embodiment. Either of switch 38 or 37 can be used to disconnect the LED 8 from a source of power during day light. Switch 38 can be an internal switch and switch 37 can be an external kill switch. When the source of electricity is connected, switch 39 disconnects the solar panel 9 from the circuit. The electricity can be used either to charge the battery 40, to light the LED 8, or to both charge the battery 40 and light the LED 8.

### REFERENCES

1. Silhouette body
2. Arm
3. Rod
4. Net
5. Design element (butterfly/flower)
6. Wire (from silhouette)
7. Wire for LED
8. LED
9. Kite
10. Solar panel
11. support structure
12. Balloon
13. Stake
14. Legs merged
15. Legs
16. Cap/Hat
17. Hand
18. Ring
19. Dress
20. Boot
21. Frusto-Conical
22. Support Balloon Wire
23. Kite String
24. Solar Panel Housing
25. Side Way Support Rod
26. Umbrella Rod
27. Umbrella
34. External Source of Electricity
35. External Source of Electricity Switch
36. Solar Panel Battery Charging Switch
37. External Switch
38. Battery Connection Switch
39. Nighttime External Source of Electricity Switch (Non-battery)
40. Rechargeable Battery

What is claimed is:

1. A lighting product, comprising:
a) a silhouette;
b) a solar panel attached to the silhouette;
c) a rechargeable battery in electronic communication with the solar panel; and
d) a light source in electronic communication with the rechargeable battery for powering the light source.

2. The lighting product of claim 1, wherein the silhouette represents an outline of a boy or a girl.

3. The lighting product of claim 1, further comprising a member attached to the silhouette.

4. The lighting product of claim 3, wherein the member is configured to be held by a hand.

5. The lighting product of claim 4, wherein the member has a rod that is configured to be held by a hand through the rod or a string.

6. The lighting product of claim 3, wherein the member is an umbrella, a net, a kite, or a balloon.

7. The lighting product of claim 1, wherein the light sources are not placed on the silhouette

8. The lighting product of claim 3, wherein the light sources are placed on the member.

9. The lighting product of claim 1, wherein the light sources are a plurality of spaced LEDs.

10. The lighting product of claim 1, wherein a front side of the silhouette is flat and uniform.

11. The lighting product of claim 1, wherein the solar panel is placed on a back of the silhouette.

12. The lighting product of claim 1, wherein the silhouette has a rod on the back side.

13. The lighting product of claim 12, wherein the solar panel is attached to the rod.

14. The lighting product of claim 3, wherein the member has a round portion, and the wire the plurality of the light sources wraps around the member.

15. The lighting product of claim 1, wherein the silhouette is configured to be attached to a ground.

16. A lighting product, comprising:
a) a silhouette having an outline of a person with at least one arm, the silhouette having a front and a back side;
b) a solar panel housing comprising a rechargeable battery and a solar panel in electronic communication with the each other attached to the back side of the silhouette;
c) a connector attached to the arm of the silhouette;
d) a decorative member attached to the connector,
e) a plurality of lights placed on the decorative member,
wherein the plurality of lights are powered by the rechargeable battery.

17. The lighting product of claim 16, wherein the decorative member is a balloon, kite, umbrella or a net.

18. The lighting product of claim 16, wherein the connector is a string or a rod.

19. The lighting product of claim 16, further comprising a support structure on the back side of the silhouette for attaching the solar panel housing.

20. The lighting product of claim 16, wherein the silhouette is configured to be attached to a ground.
